(19) United States
(12) Patent Application Publication
(10) Pub. No.: US 2011/0132560 A1
(43) Pub. Date: Jun. 9, 2011

(54) GYPSUM PRODUCT

(76) Inventors: Tarja Turkki, Helsinki (FI); Jonni Ahlgren, Espoo (FI)

(21) Appl. No.: 13/058,646

(22) PCT Filed: Apr. 20, 2009
(86) PCT No.: PCT/FI2009/050287

§ 371 Date: Feb. 11, 2011

(30) Foreign Application Priority Data
Aug. 11, 2008 (FI) 20085767

(51) Int. Cl. D21H 17/67; C04B 14/38; C08K 3/30

(52) U.S. Cl. 162/181.3; 106/461; 106/471; 524/423

(57) ABSTRACT

A gypsum-fibre composite product, wherein the gypsum appears as crystals on the surface of the fibre and wherein the gypsum crystals are obtained by contacting calcium sulphate hemihydrate and/or calcium anhydrite and an aqueous fibre suspension. Also disclosed is a process for the preparation of the gypsum-fibre composite product. The composite product can be used as a filler pigment or coating pigment in the production of paper.

### BACKGROUND OF THE INVENTION

The invention relates to a gypsum-fibre composite product. The gypsum-fibre composite product can be used as a coating pigment or a filler pigment in the production of paper. The invention also relates to a process for the preparation of the gypsum-fibre composite product. In the production of paper improved retention of the filler pigment and homogenous filler distribution can be obtained.

A papermaking process starts with stock preparation where cellulosic fibers are mixed with water and mineral filler (usually clay or calcium carbonate or also gypsum). The obtained slurry is delivered by means of a head box on a forming fabric or press fabric or wire to form a fibrous web of cellulosic fibers at the forming section of the paper machine. Then water is drained in the draining section and the formed web is conducted to the press section including a series of roll presses where additional water is removed. The web is then conducted to the drying section of the paper machine where most of the remaining water is evaporated typically by means of steam-heated dryer drums. Post drying operations include calendering where the dry paper product passes between rolls under pressure, thereby improving the surface smoothness and gloss and making the caliper/thickness profile more uniform. There are various calenders such as machine calenders where the rolls usually are steel rolls and include a heated roll (thermo roll).

Gypsum or calcium sulphate dihydrate CaSO₄.2H₂O is suitable as material for both coating pigment and filler, especially in paper products. Especially good coating pigment and filler is obtained if the particular gypsum has high brightness, gloss and opacity. The gloss is high when the particles are sufficiently small, flat and broad (platy). The opacity is high when the particles are refractive, small and of equal size (narrow particle size distribution).

The morphology of the gypsum product particles can be established by examining scanning electron micrographs. Useful micrographs are obtained e.g. with a scanning electron microscope of the type Philips FEI XL 30 FEG.

The size of the gypsum product particles is expressed as the weight average diameter D₅₀ of the particles contained therein. More precisely, D₅₀ is the diameter of the presumably round particle, smaller than which particles constitute 50% of the total particle weight. D₅₀ can be measured with an appropriate particle size analyzer, such as Sedigraph 5100.

The flatness of a crystal means that it is thin. The form of flat crystals is suitably expressed by means of the shape ratio (SR). The SR is the ratio of the crystal length (the longest measure) to the crystal thickness (the shortest transverse measure). By the SR of the claimed gypsum product is meant the average SR of its individual crystals.

The platyness of a crystal means that it is broad. Platyness is suitable expressed by means of the aspect ratio (AR). The AR is the ratio between the crystal length (the longest measure) and the crystal width (the longest transverse measure). By the AR of the claimed gypsum product is meant the average AR of its individual crystals.

Both the SR and the AR of the gypsum product can be estimated by examining its scanning electron micrographs. A suitable scanning electron microscope is the above mentioned Philips FEI XL 30 FEG.

Equal crystal particle size means that the crystal particle size distribution is narrow. The width is expressed as the gravimetric weight distribution WPSD and it is expressed as (D₇₅−D₂₅)/D₅₀ wherein D₇₅, D₂₅ and D₅₀ are the diameters of the presumably round particles, smaller than which particles constitute 75, 25 and 50%, respectively, of the total weight of the particles. The width of the particle distribution is obtained with a suitable particle size analyzer such as the above mentioned type Sedigraph 5100.

Gypsum occurs as a natural mineral or it is formed as a by-product of chemical processes, e.g. as phosphogypsum or flue gas gypsum. In order to refine the gypsum further by crystallising it into coating pigment or filler, it must first be calcined into calcium sulphate hemihydrate (CaSO₄.½H₂O), after which it may be hydrated back by dissolving the hemihydrate in water and precipitating to give pure gypsum. Calcium sulphate may also occur in the form of anhydrite lacking crystalline water (CaSO₄).

Depending on the calcination conditions of the gypsum raw material, the calcium sulphate hemihydrate may occur in two forms; as α- and β-hemihydrate. The β-form is obtained by heat-treating the gypsum raw material at atmospheric pressure while the α-form is obtained by treating the gypsum raw material at a steam pressure which is higher than atmospheric pressure or by means of chemical wet calcination from salt or acid solutions at e.g. about 45° C.

WO 88/05423 discloses a process for the preparation of gypsum by hydrating calcium sulphate hemihydrate in an aqueous slurry thereof, the dry matter content of which is between 20 and 25% by weight. Gypsum is obtained, the largest measure of which is from 100 to 450 μm and the second largest measure of which is from 10 to 40 μm.

AU 620857 (EP 0334292 A1) discloses a process for the preparation of gypsum from a slurry containing not more than 33.33% by weight of ground hemihydrate, thereby yielding needle-like crystals having an average size of between 2 and 200 μm and an aspect ratio between 5 and 50. See page 15, lines 5 to 11, and the examples of this document.

US 2004/0241082 describes a process for the preparation of small needle-like gypsum crystals (length from 5 to 35 μm, width from 1 to 5 μm) from an aqueous slurry of hemihydrate having a dry matter content of between 5 and 25% by weight. The idea in this US document is to reduce the water solubility of the gypsum by means of an additive in order to prevent the crystals from dissolving during paper manufacture.

DE 32 23 178 C1 discloses a process for producing organic fibres coated with one or more mineral substances. One embodiment comprises mixing cellulose fibres, gypsum and water. The mixture is compacted to give a plastic mass which subsequently is dried and mechanically comminuted to give fine particles. The obtained product can be used as an additive or filler e.g. in bitumen masses or putties.

WO 2008/092990 discloses a gypsum product consisting of intact crystals having a size from 0.1 to 2.0 μm. The crystals have a shape ratio SR of at least 2.0, preferably between 2.0 and 50, and a aspect ratio AR between 1.0 and 10, preferably between 1.0 and below 5.0.

WO 2008/092991 discloses a process for the preparation of a gypsum product wherein calcium sulphate hemihydrate and/or calcium sulphate anhydrite and water are contacted so that the calcium sulphate hemihydrate and/or calcium sulphate anhydrite and the water react with each other and form a crystalline gypsum product. The formed reaction mixture has a dry matter content of between 34 and 84% by weight.

### DESCRIPTION OF THE INVENTION

The aim of the invention is to provide a gypsum-fibre composite product, wherein the gypsum is crystallized on the surface of the fibre and attached fairly strongly to the fibre. The composite product can be used as a filler pigment or coating pigment in the production of paper. In the production of paper improved retention of the filler pigment and homogenous filler distribution can be obtained. Also higher filler load can be obtained. The gypsum-fibre composite product of the invention is especially well suited for the production of fine paper.

Thus, according to a first aspect of the invention there is provided a gypsum-fibre composite product, wherein the gypsum appears as crystals on the surface of the fibre and wherein the gypsum crystals are obtained by contacting calcium sulphate hemihydrate and/or calcium sulphate anhydrite and an aqueous fibre suspension.

The gypsum is attached to the fibre and consequently the gypsum-fibre composite is shown by most measurement methods as a single piece. The shape and size of the gypsum can roughly be estimated by means of microscopic images. The gypsum crystals attached to the fibre can have the shapes and sizes described in WO 2008/092990 and WO 2008/092991. However, according to the invention, the crystallized gypsum can also be needle-like.

The size of the gypsum crystals is preferably from 0.1 to 5.0 μm, more preferably from 0.1 to 4.0 μm, and most preferably from 0.2 to 4.0 μm. The size of the gypsum crystals may also be from 0.1 to 2.0 μm or from 0.2 to 2.0 μm.

Preferably, the fibre of the gypsum-fibre composite product comprises a cellulosic fibre such as a chemical, mechanical, chemi-mechanical or deinked pulp fibre or a synthetic fibre, such as a polyolefine, e.g., polypropene. Chemical pulps include kraft pulp and sulphite pulp. Mechanical pulps include stone groundwood pulp (SGW), refiner mechanical pulp (RMP), pressure groundwood (PGW), thermomechanical pulp (TMP), and also chemically treated high-yield pulps such as chemithermomechanical pulp (CTMP). Deinked pulp can be made using mixed office waste (MOW), newsprint (ONP), magazines (OMG), etc. Also mixtures of different pulps can be used.

Preferably the weight ratio of gypsum to fibre on dry basis is in the range from 95:5 to 50:50, and more preferably from 75:25 to 50:50.

According to the invention the gypsum-fibre composite product may additionally comprise additional substances such as a natural or synthetic polymer binder and/or an optical brightener and/or a rheology modifier and/or sizing agents. The sizing agent may be a rosin size or a reactive size such as alkyl ketene dimer (AKD) or alkenyl succinic anhydride (ASA).

As was stated before, the gypsum product of the invention is typically a coating or filler pigment. In addition to use as a paper additive, it can also be used as plastics filler, and as a raw material in glass industry, cosmetics, printing inks, building materials and paints.

According to one embodiment of the invention, the composite product is a coating pigment and comprises gypsum crystals preferably having a size of between 0.1 and 1.0 μm, more preferably between 0.5 and 1.0 μm. According to another embodiment, it is a filler and comprises gypsum crystals preferably having a size of between 1.0 and 5.0 μm, more preferably between 1.0 and 4.0 μm. The gypsum crystals in the filler composite may also have a size of between 1.0 and below 2.0 μm.

According to a second aspect of the invention there is provided a process for the preparation of a gypsum-fibre composite product, comprising contacting calcium sulphate hemihydrate and/or calcium sulphate anhydrite and an aqueous fibre suspension to form gypsum crystals on the surface of the fibre.

Preferably the weigh ratio of calcium sulphate hemihydrate and/or calcium sulphate anhydrite to water in the crystallization is in the range from 0.03 to 0.6:1, more preferably from 0.05 to 0.5:1.

Preferably the dry fiber content in the crystallization is from 3 to 30% by weight.

Preferably the content of calcium sulphate hemihydrate and/or calcium sulphate anhydrite in the crystallization is from 10 to 57% by weight.

The process of the invention may additionally comprise the steps of drying and comminuting the obtained product to form a gypsum-fibre composite product in the form of particles.

According to the invention, a fixative can be introduced into the crystallization.

The fixative can be selected from the group consisting of poly aluminium chloride, poly diallyldimethylammonium chloride (poly DADMAC), anionic and cationic polyacrylates.

According to the invention the crystallization can be carried out in the absence of crystallization habit modifiers.

According to the invention the crystallization can also be carried out in the presence of a crystallization habit modifier.

The crystallization habit modifier can be added to water or aqueous fibre suspension before the calcium sulphate hemihydrate and/or calcium sulphate anhydrite.

The temperature of the water in the reaction mixture can be anything between 0 and 100° C. Preferably, the temperature is between 0 and 80° C., more preferably between 0 and 50° C., even more preferably between 0 and 40° C., most preferably between 0 and 25° C.

According to one embodiment of the invention, the crystallization habit modifier is an inorganic acid, oxide, base or salt. Examples of useful inorganic oxides, bases and salts are AlF₃, Al₂(SO₄)₃, CaCl₂, Ca(OH)₂, H₃BO₄, NaCl, Na₂SO₄, NaOH, NH₄OH, (NH₄)₂SO₄, MgCl₂, MgSO₄ and MgO.

According to another embodiment, the crystallization habit modifier is an organic compound, which is an alcohol, an acid or a salt. Suitable alcohols are methanol, ethanol, 1-butanol, 2-butanol, 1-hexanol, 2-octanol, glycerol, i-propanol and alkyl polyglucoside based C₈-C₁₀-fatty alcohols.

The crystallization habit modifier is preferably a compound having in its molecule one or several carboxylic or sulphonic acidic groups, or a salt of such a compound. Among the organic acids may be mentioned carboxylic acids such as acetic acid, propionic acid, succinic acid, citric acid, tartaric acid, ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), and sulphonic acids such as amino-1-naphthol-3,6-disulphonic acid, 8-amino-1-naphthol-3,6-disulphonic acid, 2-aminophenol-4-sulphonic acid, anthrachinone-2,6-disulphonic acid, 2-mercaptoethanesulphonic acid, poly(styrene sulphonic acid), poly(vinylsulphonic acid), as well as the di-, tetra- and hexa-aminostilbenesulfonic acids.

Among the organic salt may be mentioned the salts of carboxylic acids such as Mg formiate, Na- and NH₄-acetate, Na₂-maleate, NH₄-citrate, Na₂-succinate, K-oleate, K-stearate, Na₂-ethylenediamine tetraacetic acid (Na₂-EDTA), Na₆-aspartamic acid ethoxy succinate (Na₆-AES) and Na₆-aminotriethoxy succinate (Na₆-TCA).

Also the salt of sulphonic acids are useful, such as Na-n-(C₁₀-C₁₃)-alkylbenzene sulphonate, C₁₀-C₁₆-alkylbenzene sulphonate, Na-1-octyl sulphonate, Na-1-dodecane sulphonate, Na-1-hexadecane sulphonate, the K-fatty acid sulphonates, the Na—C₁₄-C₁₆-olefin sulphonate, the Na-alkylnaphthalene sulphonates with anionic or non-ionic surfactants, di-K-oleic acid sulphonates, as well as the salts of di-, tetra-, and hexaminostilbene sulphonic acids. Among organic salts containing sulphur should also be mentioned the sulphates such as the C₁₂-C₁₄-fatty alcohol ether sulphates, Na-2-ethyl hexyl sulphate, Na-n-dodecyl sulphate and Na-lauryl sulphate, and the sulphosuccinates such as the monoalkyl polyglycol ether of Na-sulphosuccinate, Na-dioctyl sulphosuccinate and Na-dialkyl sulphosuccinate.

Phosphates may also be used, such as the Na-nonylphenyl- and Na-dinonyl phenylethoxylated phosphate esters, the K-aryl ether phosphates, as well as the triethanolamine salts of polyaryl polyetherphosphate.

As crystallization habit modifier may also be used cationic surfactants such as octyl amine, triethanol amine, di(hydrogenated animal fat alkyl) dimethyl ammonium chloride, and non-ionic surfactants such as a variety of modified fatty alcohol ethoxylates. Among useful polymeric acids, salts, amides and alcohols may be mentioned the polyacrylic acids and polyacrylates, the acrylate-maleate copolymers, polyacrylamide, poly(2-ethyl-2-oxazoline), polyvinyl phosphonic acid, the copolymer of acrylic acid and allylhydroxypropyl sulphonate (AA-AHPS), poly-α-hydroxyacrylic acid (PHAS), polyvinyl alcohol, and poly(methyl vinyl ether-alt.-maleic acid).

Especially preferable crystallization habit modifiers are ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), the di-, tetra- and hexa-aminostilbenesulfonic acids and their salts such as Na-aminotriethoxy succinate (Na₆-TCA), as well as the alkylbenzenesulphonates.

In the process of the invention, the crystallization habit modifier can be used in an amount of 0.01 to 5.0%, most preferably 0.02-1.78%, based on the weight of the calcium sulphate hemihydrate and/or calcium sulphate anhydrite.

In the process according to the invention, β-calcium sulphate hemihydrate is typically used. It may be prepared by heating gypsum raw-material to a temperature of between 140 and 300° C., preferably from 150 to 200° C. At lower temperatures, the gypsum raw-material is not sufficiently dehydrated and at higher temperatures it is over-dehydrated into anhydrite. Calcinated calcium sulphate hemihydrate usually contains impurities in the form of small amounts of calcium sulphate dihydrate and/or calcium sulphate anhydrite. It is preferable to use β-calcium sulphate hemihydrate obtained by flash calcination, e.g by fluid bed calcination, whereby the gypsum raw-material is heated to the required temperature as fast as possible. However, it is also possible to use α-calcium sulphate hemihydrate in the crystallization.

It is also possible to use calcium sulphate anhydrite as starting material for the process of the invention. The anhydrite is obtained by calcination of gypsum raw material. There are three forms of anhydrite; the first one, the so called Anhydrite I, is unable to form gypsum by reaction with water like the insoluble Anhydrites II-u and II-E. The other forms, the so called Anhydrite III, also known as soluble anhydrite has three forms: β-anhydrite III, β-anhydrite III′, and α-anhydrite III and Anhydrite II-s form pure gypsum upon contact with water.

As the calcium sulphate hemihydrate and/or calcium sulphate anhydrite, aqueous fibre suspension and optionally crystallization habit modifier have been contacted, they are allowed to react into calcium sulphate dihydrate i.e. gypsum. The reaction takes e.g. place by mixing, preferably by mixing strongly, said substances together for a sufficient period of time, which can easily be determined experimentally. At high dry matter contents strong mixing is necessary because, the slurry is thick and the reagents do not easily come into contact with each other. Preferably the hemihydrate and/or anhydrite, the aqueous fibre suspension and optionally the crystallization habit modifier are mixed at the above mentioned temperature given for the water. The initial pH is typically between 3.5 and 9.0, most preferably between 4.0 and 7.5. It is preferred that the initial pH is acidic, preferably between 3 and 7, more preferably between 3 and 6. If necessary, the pH is regulated by means of an aqueous solution of NaOH and/or H₂SO₄, typically a 10% solution of NaOH and/or H₂SO₄.

Because gypsum has a lower solubility in water than hemihydrate and soluble anhydrite, the gypsum formed by the reaction of hemihydrate and/or anhydrite with water immediately tends to crystallize from the water medium. The crystallization according to the invention can be regulated by means of the above mentioned crystallization habit modifier so that a useful product according to the invention is obtained.

The gypsum-fibre composite product of the present invention can also be treated with other additives. A typical additive is a biocide which prevents the activity of microorganisms when storing and using the product.

According to a third aspect of the invention there is provided a paper product comprising the gypsum-fibre composite product of the invention as a filler pigment or coating pigment.

An especially preferred paper product is fine paper which typically is uncoated and preferably woodfree (prepared from chemical pulp). Examples of fine papers are writing and printing grade papers including offset, bond, duplicating and photocopying papers.

Preferably, the amount of the gypsum-fibre composite product in the paper product is from 20 to 100% by weight on dry basis. Other preferred ranges are from 20 to 90% and 20 to 80% and 20 to 70% and 20 to 60% and 20 to 50% by weight on dry basis. Additional preferred ranges are from 30 to 100% and from 40 to 100% and from 50 to 100% and 60 to 100% by weight on dry basis.

The paper product of the present invention preferably comprises in addition to the gypsum-fibre composite product cellulosic fibres.

Preferably, the cellulosic fibres comprise conventional papermaking pulp fibres including chemical, mechanical, chemi-mechanical or deinked pulp fibres. Chemical pulps include kraft pulp and sulphite pulp. Mechanical pulps include stone groundwood pulp (SGW), refiner mechanical pulp (RMP), pressure groundwood (PGW), thermomechanical pulp (TMP), and also chemically treated high-yield pulps such as chemithermomechanical pulp (CTMP). Deinked pulp can be made using mixed office waste (MOW), newsprint (ONP), magazines (OMG) etc. Also mixtures of different pulps can be used.

Said cellulosic fibres can be similar as or different from the fiber in the gypsum-fibre composite product, and preferably the fibres are similar.

For fine papers the cellulosic fibres are preferably kraft pulp fibres.

The amount of the gypsum-fibre composite product in the paper product is preferably from 10 to 60%, more preferably from 20 to 50% by weight on dry basis. Correspondingly the amount of said cellulosic fibres in the paper product is preferably from 40 to 90%, more preferably from 50 to 80% by weight on dry basis.

Additionally the invention relates to the use of the gypsum-fibre composite product of the invention as a filler pigment or coating pigment in the production of paper.

### SHORT DESCRIPTION OF THE DRAWINGS

FIGS. 1-8 show electron microscope micrographs of calcium sulfate dihydrate-fiber composite products of examples 1-8, FIG. 9 shows electron microscope micrographs of paper samples, and FIGS. 10-16 show various properties of paper samples.

FIG. 1a shows SEM micrograph of calcium sulfate dihydrate/TMP composite at hemihydrate solids content of 18% (HH/(HH+water)).

FIG. 1b shows SEM micrograph of the same composite as in FIG. 1a washed in saturated calcium sulfate solution.

FIG. 2a shows SEM micrograph of calcium sulfate dihydrate/TMP composite at hemihydrate solids content of 42% (HH/(HH+water)).

FIG. 2b shows SEM micrograph of the same composite as in FIG. 2a washed in saturated calcium sulfate solution.

FIG. 3 shows SEM micrograph of calcium sulfate dihydrate/eucalyptus kraft pulp composite at hemihydrate solids content of 6.25% (HH/(HH+water)).

FIG. 4 shows SEM micrograph of the fibers from calcium sulfate dihydrate/eucalyptus kraft pulp composite at hemihydrate solids content of 7.5% (HH/(HH+water)).

FIG. 5a shows SEM micrograph of calcium sulfate dihydrate/pine kraft pulp composite using poly aluminum chloride as fixative, composite being washed with saturated calcium sulfate solution.

FIG. 5b shows SEM micrograph of the same composite as in FIG. 5a being stirred with Heidolph laboratory mixer at 350 rpm for a couple of minutes.

FIG. 6a shows SEM micrograph of calcium sulfate dihydrate/pine kraft pulp composite using poly-DADMAC as fixative, composite being washed with saturated calcium sulfate solution.

FIG. 6b shows SEM micrograph of the same composite as in FIG. 6a being stirred with Heidolph laboratory mixer at 350 rpm for a couple of minutes.

FIG. 7 shows SEM micrograph of calcium sulfate dihydrate/birch kraft pulp composite washed with saturated calcium sulfate solution.

FIG. 8 shows SEM micrograph of calcium sulfate dihydrate/plastic fiber composite washed with saturated calcium sulfate solution.

FIGS. 9a, 9b and 9c show cross sectional SEM images of uncalendered paper samples.

FIG. 10 shows Yellowness of paper samples.

FIG. 11 shows Light scattering and opacity of paper samples.

FIG. 12 shows ISO Brightness, CIE Whiteness and CIE L* of paper samples.

FIG. 13 shows PPS Roughness of both sides of uncalendered paper samples.

FIG. 14 shows PPS Roughness of uncalendered and calendered paper samples.

FIG. 15 shows air permeability (Bendtsen porosity) of paper samples.

FIG. 16 shows light scattering vs. tensile index of paper samples.

### EXAMPLES

In the following the invention will be illustrated in more detail by means of examples. The purpose of the examples is not to restrict the scope of the claims. In this specification the percentages refer to % by weight unless otherwise specified.

First, general information about the syntheses and product analyses is disclosed. Then, data about each example is presented.

### Synthesis

General information is first presented. A method optimization for the paper pigments was carried out. The parameters were:

| | |
|---|---|
| HH (initial hemihydrate, w-%) | 5-57 |
| Fiber concentration (w-%) | 3-30 |
| Additive concentration (w-% of DH (dihydrate) ) | 0.100-1 |

The reaction was carried out at system pH. The amount of habit modifier chemical is calculated as percent of the precipitated calcium sulfate dihydrate (w-% of DH)

The experiments were performed with the following equipment.

The reactor was of Hobart type N50CE. The hemihydrate and the chemicals are added batchwise to the aqueous fiber suspension phase and a hemihydrate slurry with an initial solids of 5-57 w-% is obtained. Mixing speed is about 250-500 rpm. Reaction is carried out at system pH.

### Analysis

Morphology of calcium sulfate dihydrate was studied by using FEI XL 30 FEG scanning electron microscope. Conversion of hemihydrate to dihydrate was analyzed using Mettler Toledo TGA/SDTA85 1/1100-thermogravimetric analyzer (TG). Crystal structure was determined with Philips X'pert x-ray powder diffractometer (XRD).

### Example 1

800 g of water was placed into the Hobart N50 CE laboratory mixer. Couple of drops of biocide (Fennosan IT 21) was added.

200 g of TMP (Thermomechanical pulp) with solids content of 36% was added to the mixer.

3. Fluidized bed calcined β-calcium sulphate hemihydrate was evenly added to the mixer with the operation speed of the stirrer set to position 1. The total amount of hemihydrate added was 200 g (giving 18% by weight of HH/(HH+water)). After the addition, the operation speed of the stirrer was raised to position 2. Composite was stirred for five minutes.

4. Wait for the formation of calcium sulfate dihydrate for one hour.

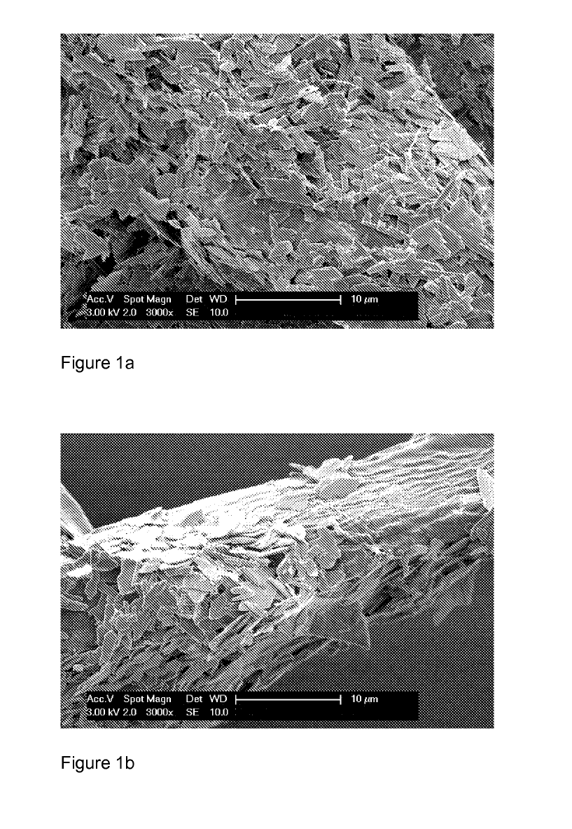

The obtained pigment-fiber composite is shown in FIG. 1a, after washing with calcium sulfate saturated water in FIG. 1b.

### Example 2

430 g of water was placed into the Hobart N50 CE laboratory mixer. Couple of drops of biocide (Fennosan IT 21) was added.

570 g of TMP (Thermomechanical pulp) with solids content of 36% was added to the mixer.

Fluidized bed calcined n-calcium sulphate hemihydrate was evenly added to the mixer with the operation speed of the stirrer set to position 1. The total amount of hemihydrate added was 570 g (giving 42% by weight of HH/(HH+water)). After the addition, the operation speed of the stirrer was raised to position 2. Composite was stirred for five minutes.

4. Wait for the formation of calcium sulfate dihydrate for one hour.

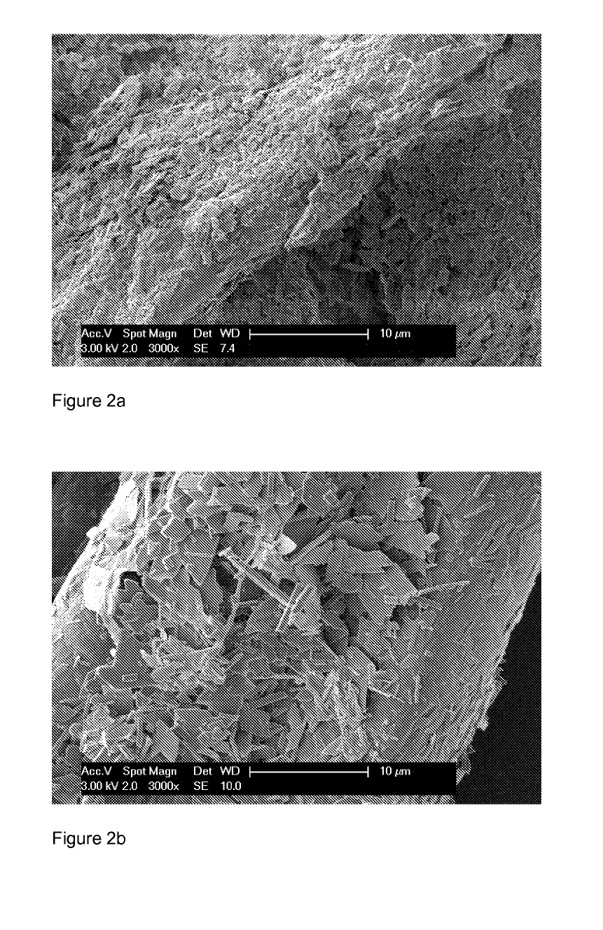

The obtained pigment-fiber composite is shown in FIG. 2a, after washing with calcium sulfate saturated water in FIG. 2b.

### Example 3

456.5 g of eucalyptus kraft pulp with solids content of 17.7% was placed into the Hobart N50 CE laboratory mixer.

Fluidized bed calcined n-calcium sulphate hemihydrate is evenly added to the mixer with the operation speed of the stirrer set to position 1. The total amount of hemihydrate added was 25 g (giving 6.25% by weight of HH/(HH+water)). After the addition, the operation speed of the stirrer was raised to position 2. Composite was stirred for five minutes.

3. Wait for the formation of calcium sulfate dihydrate for one hour.

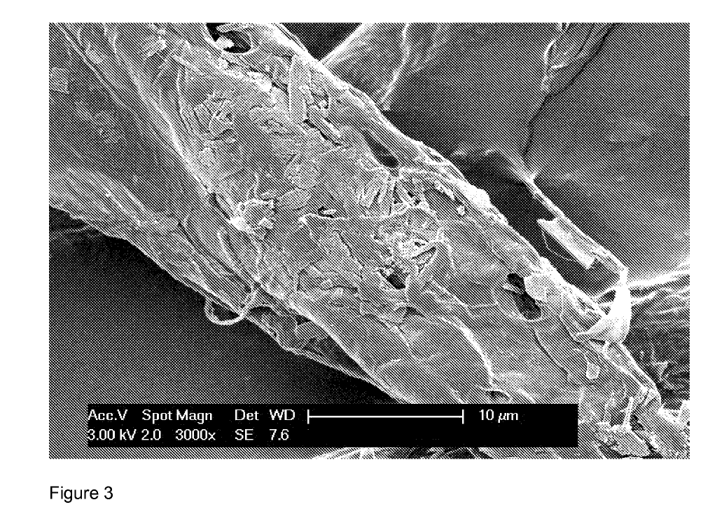

The obtained pigment-fiber composite after washing with calcium sulfate saturated water is shown in FIG. 3.

### Example 4

47 g of water was placed into the Hobart N50 CE laboratory mixer. Couple of drops of biocide (Fennosan IT 21) is added.

295.5 g of eucalyptus kraft pulp with solids content of 17.7% was added to the mixer.

Fluidized bed calcined β-calcium sulphate hemihydrate was evenly added to the mixer with the operation speed of the stirrer set to position 1. The total amount of hemihydrate added is 25 g (giving 7.5% by weight of HH/(HH+water)). After the addition the operation speed of the stirrer was raised to position 2. Composite was stirred for five minutes.

Wait for the formation of calcium sulfate dihydrate for one hour.

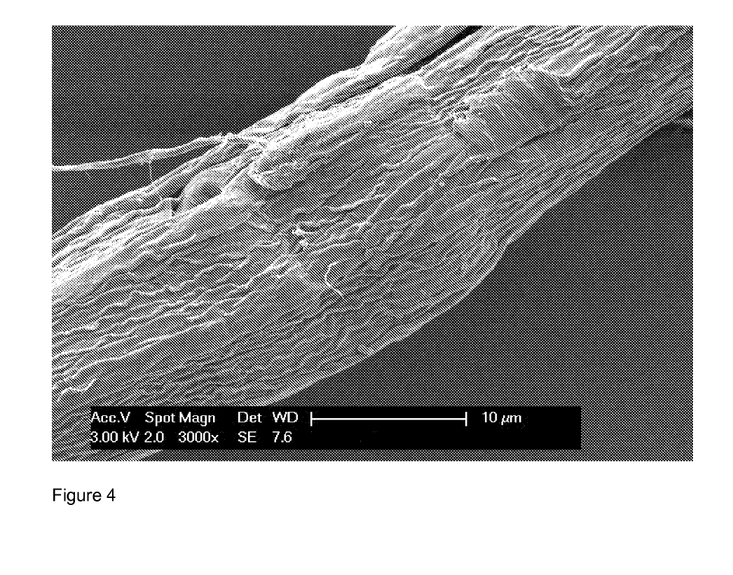

The obtained fiber product is shown in FIG. 4.

### Example 5

44.8 g of water was placed into the Hobart N50 CE laboratory mixer. 1.6 g of poly aluminum chloride and couple of drops of biocide (Fennosan IT 21) is added.

640 g of pine kraft pulp with solids content of 7% was added to the mixer.

Fluidized bed calcined β-calcium sulphate hemihydrate was evenly added to the reactor with the operation speed of the stirrer set to position 1. The total amount of hemihydrate added was 160 g (giving 20% by weight of HH/(HH+water)). After the addition, the operation speed of the stirrer was raised to position 2. Composite is stirred for five minutes.

Wait for the formation of calcium sulfate dihydrate for one hour.

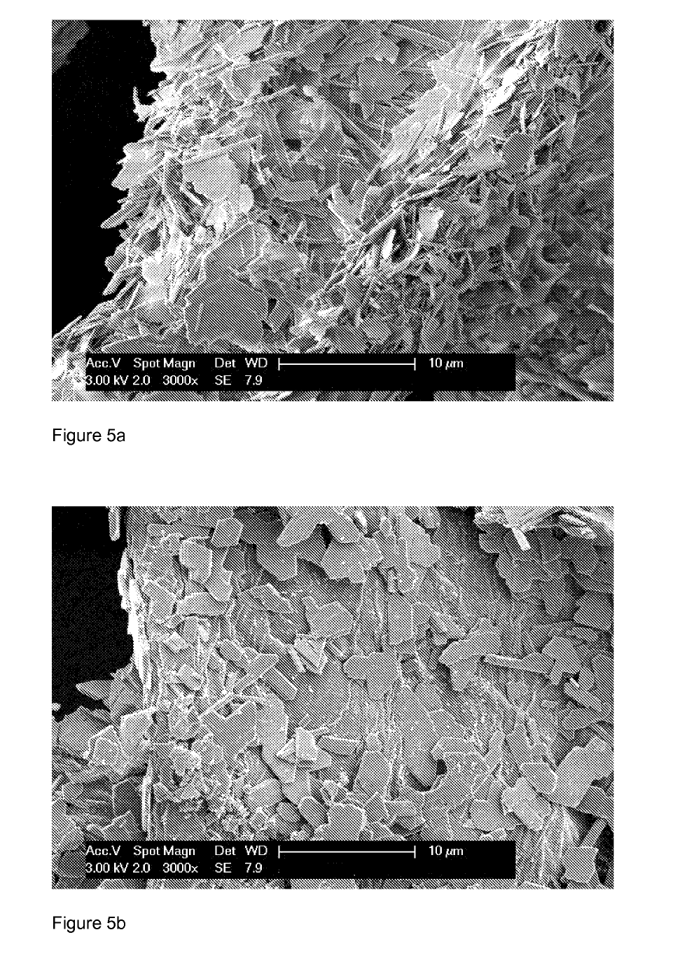

The obtained pigment-fiber composite after washing with calcium sulfate saturated water is shown in FIG. 5.

### Example 6

15.8 g of water was placed into the Hobart N50 CE laboratory mixer. 0.6 g of poly DADMAC and couple of drops of biocide (Fennosan IT 21) is added.

226 g of pine kraft pulp with solids content of 7% was added to the mixer.

3. Fluidized bed calcined β-calcium sulphate hemihydrate was evenly added to the mixer with the operation speed of the stirrer set to position 1. The total amount of hemihydrate added was 300 g (giving 57% by weight of HH/(HH+water)). After the addition the operation speed of the stirrer was raised to position 2. Composite was stirred for five minutes.

4. Wait for the formation of calcium sulfate dihydrate for one hour.

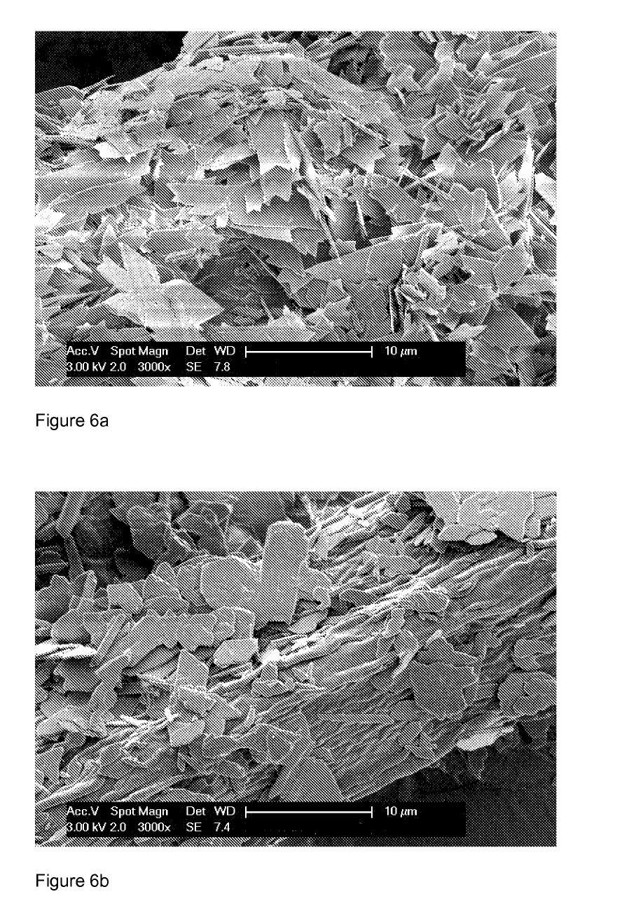

The obtained pigment-fiber composite after washing with calcium sulfate saturated water is shown in FIG. 6.

### Example 7

116 g of water was placed into the Hobart N50 CE laboratory mixer. Couple of drops of biocide (Fennosan IT 21) is added.

800 g of birch kraft pulp (solids content 14.5%) was added to the mixer.

Fluidized bed calcined β-calcium sulphate hemihydrate was evenly added to the mixer with the operation speed of the stirrer set to position 1. The total amount of hemihydrate added was 200 g (giving 20% by weight of HH/(HH+water)). After the addition the operation speed of the stirrer was raised to position 2. Composite was stirred for five minutes.

Wait for the formation of calcium sulfate dihydrate for one hour.

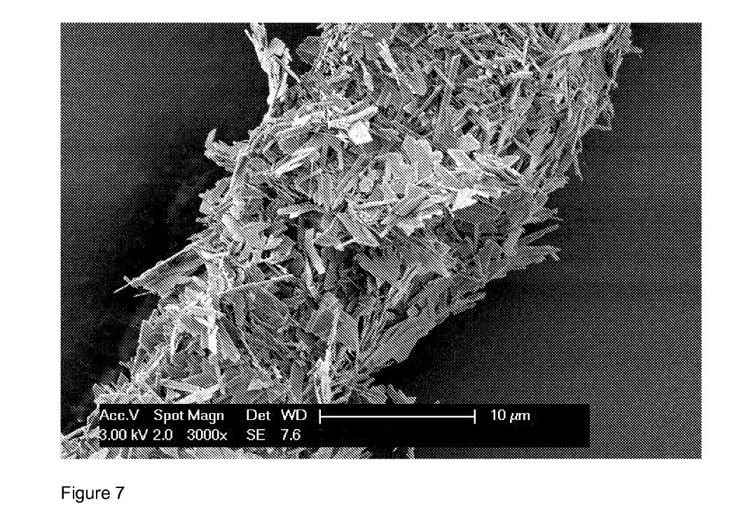

The obtained pigment-fiber composite after washing with calcium sulfate saturated water is shown in FIG. 7.

### Example 8

600 g of water was placed into the Hobart N50 CE laboratory mixer. Couple of drops of biocide (Fennosan IT 21) is added.

10 g of synthetic polypropene fiber was added to the mixer.

Fluidized bed calcined 6-calcium sulphate hemihydrate was evenly added to the mixer with the operation speed of the stirrer set to position 1. The total amount of hemihydrate added was 300 g (giving 34% by weight of HH/(HH+water)). After the addition the operation speed of the stirrer was raised to position 2. Composite was stirred for five minutes.

Wait for the formation of calcium sulfate dihydrate for one hour.

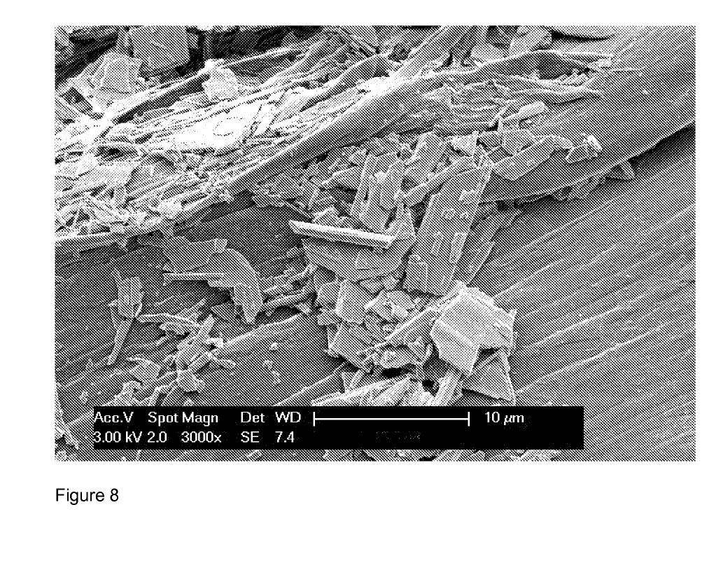

The obtained pigment-fiber composite after washing with calcium sulfate saturated water is shown in FIG. 8.

### Example 9

Application tests were carried out with pigment-fiber composite as follows.

Calcium sulphate was precipitated on eucalyptus kraft pulp refined to SR 32. Fiber solids content was 8% and hemihydrates solids 20% in the precipitation. Filler levels of the hand sheets were adjusted to 20, 30 and 40% by changing the composite/untreated pulp ratio. Composite was disintegrated using valley Hollander refiner without weights for 30 minutes. Hand sheets were prepared using Haage Rapid Koethen Sheet Former. Basis weight was 60 g/m².

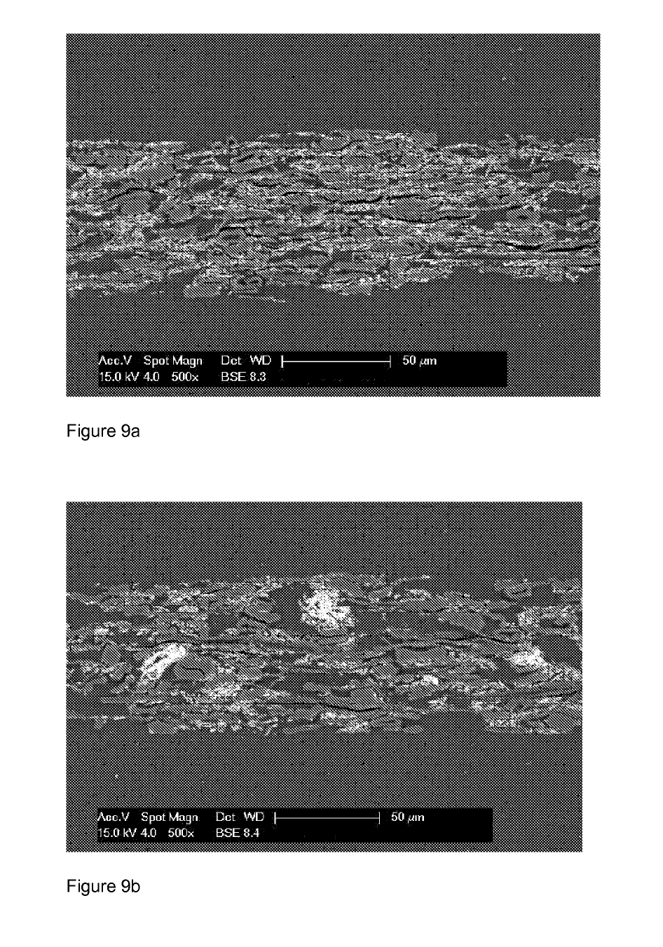

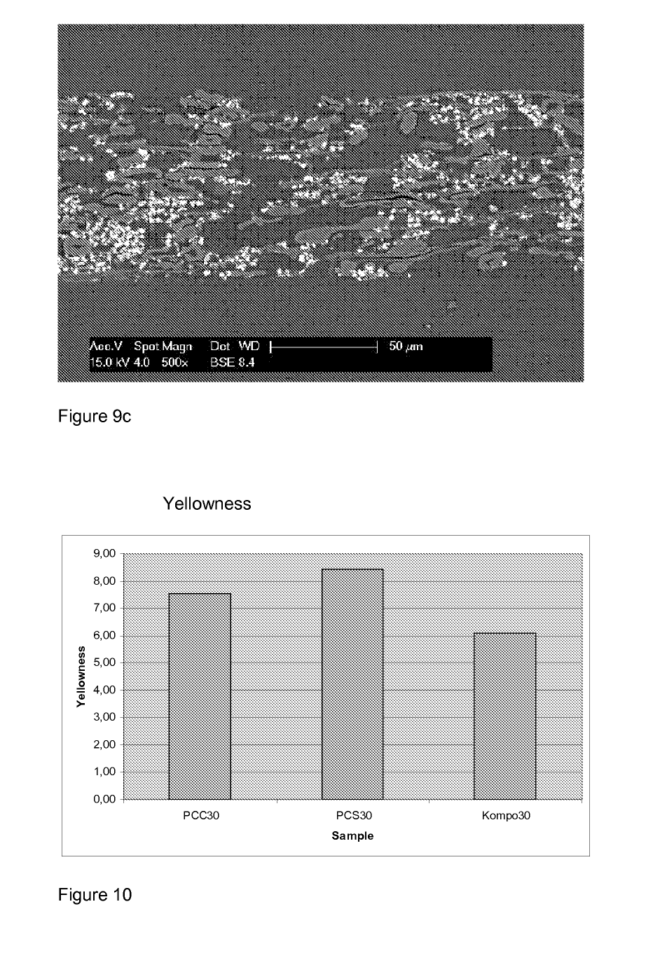

FIG. 9a shows cross sectional SEM images of uncalendered paper sheets comprising gypsum-fiber composite of the present invention, FIG. 9b shows cross sectional SEM images of uncalendered paper sheets comprising PCS (precipitated calcium sulphate) representing the prior art, and FIG. 9c shows cross sectional SEM images of uncalendered paper sheets comprising PCC (precipitated calcium carbonate) filler representing the prior art. As can be seen in FIGS. 9a-9c the paper obtained using calcium sulfate filler-fiber composite according to the present invention (FIG. 9a) is smooth, dense and has homogeneous filler distribution, whereas the papers obtained using PCS and PCC fillers (FIGS. 9b and 9c) are less smooth and dense and have inhomogeneous filler distribution.

In the following “Kompo” and “Composite” refer to the gypsum-fiber composite of the present invention, PCC stands for precipitated calcium carbonate and PCS for precipitated calcium sulphate. The FIG. 30 in, e.g., Kompo30, refers to the filler level of 30%.

Grammage was measured according to standard ISO 536,

thickness, density and bulk using ISO 534,

PPS roughness using ISO 8791-4,

gloss Tappi 75° with ISO 8254-1,

air permeability with ISO 5636-3,

ash content was determined using ISO 1762 standard by heating the samples at 850° C. for three hours,

tensile strength index was measured using L&W tensile tester and ISO standard 1924-3,

tear index was measured using ISO 1974, and

Scott Bond using T 569.

Following results were obtained.

The results in FIG. 10 show that the Yellowness (CIE yellow colour coordinate b*(C/2°)) was much lower for Kompo than for PCC and PCS.

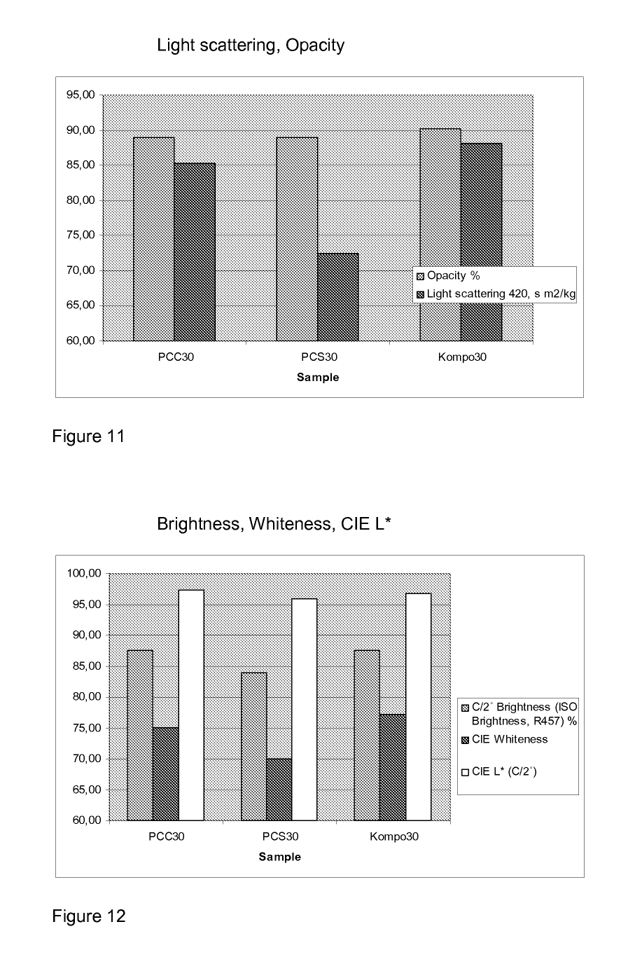

The results in FIG. 11 show that Kompo improved light scattering with about 15 units compared to PCS and with about 3 units compared to PCC. The results in FIG. 11 also show that the opacity was improved for Kompo by about 2 units compared to PCC and PCS.

The results in FIG. 12 show that the ISO-Brightness (C/2° brightness measured at R₄₅₇) for Kompo was increased compared to PCS and at the same level as for PCC. Furthermore the CIE Whiteness for Kompo was improved compared to both PCC and PCS. The CIE L*)(C/2° were equal for all three fillers. CIE L* is a measure of lightness and varies from 100 for perfect white to 0 for absolute black.

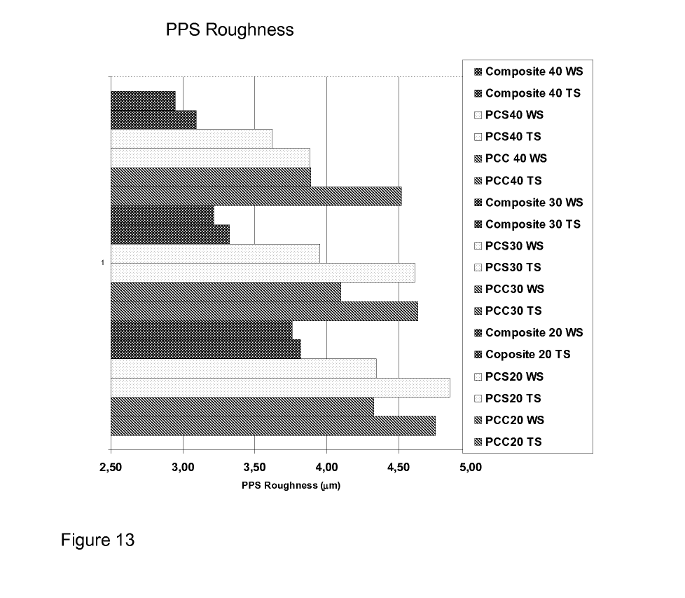

The PPS Roughness results in FIG. 13 show that smoother uncalendered paper surfaces, both top side (TS) and wire side (WS), were obtained using Composite at various filler levels as compared to PCC and PCS. Also the difference in roughness between top side (TS) and wire side (WS) was very low for Composite.

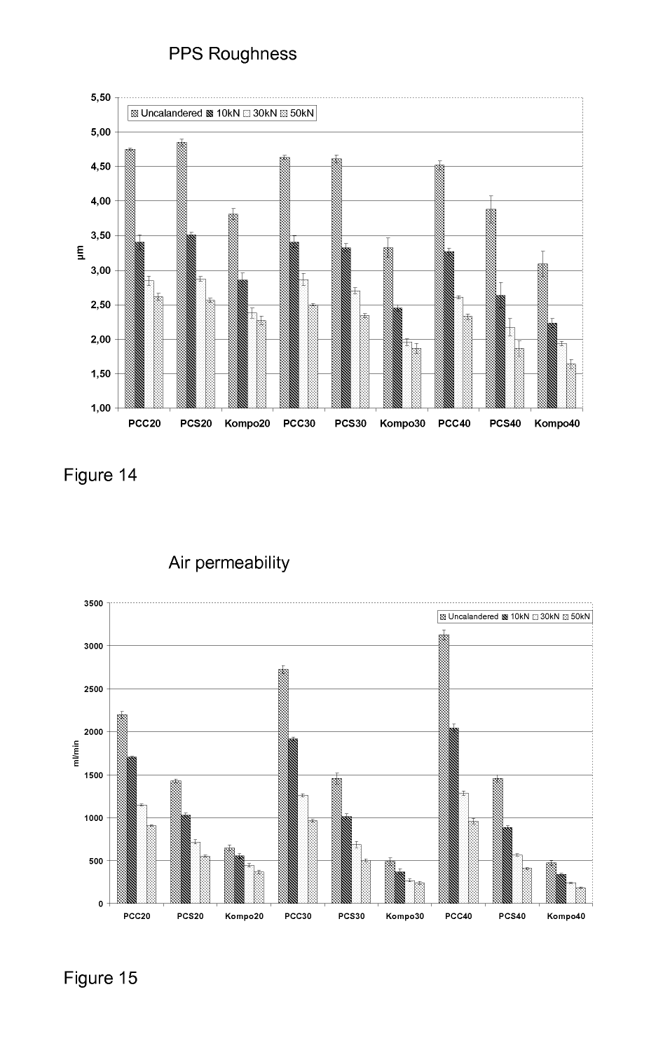

The PPS Roughness results in FIG. 14 show that the Kompo had lowest roughness for uncalendered paper samples and for calendered paper samples at all tested calendering loads (10 kN, 30 kN and 50 kN).

The results in FIG. 15 show that Air permeability, i.e. Brendtsen porosity, was lower for Kompo than for PCC and PCS for uncalendered paper samples and for calendered paper samples at all tested calendering loads (10 kN, 30 kN and 50 kN). Thus, a dense paper sheet with lower bulk was obtained using Kompo. The results also show that increasing filler content decreases the air permeability.

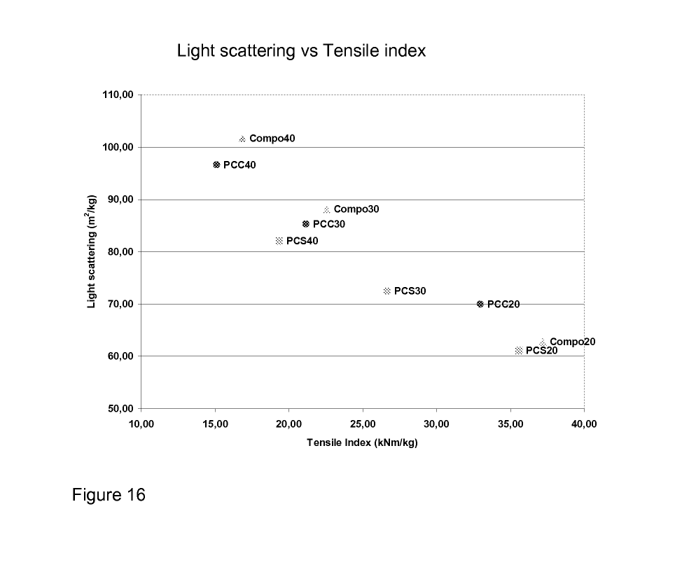

In FIG. 16, the light scattering is shown against tensile index. The results show that for the composite of the invention the scattering-tensile strength relationship is good.

Since composite samples were smoother than the other samples different calendering conditions can be used for same roughness values. Comparison at same roughness is shown in table 1 and at same bulk in table 2 for samples with filler content 30%.

In following Table 1 various paper properties are compiled.

TABLE 1

| | | | PCS- |
|---|---|---|---|
| | PCC | PCS | Composite |
| | (10 kN/m) | (10 kN/m) | (unc) |
| Roughness | 3.41 | 3.33 | 3.32 |
| Bulk | 1.45 | 1.33 | 1.49 |
| Scattering | 84.85 | 71.71 | 88.07 |
| Opacity | 88.68 | 88.35 | 90.20 |
| Filler content | 29.7 | 30.7 | 31.2 |

The results show that at the same roughness the Composite sample had highest bulk, light scattering and opacity.

In following Table 2 various paper properties are compiled.

TABLE 2

| | | | PCS- |
|---|---|---|---|
| | PCC | PCS | COMPOSITE |
| Calendering | (50 kN/m) | (30 kN/m) | (30 kN/m) |
| Bulk | 1.20 | 1.20 | 1.17 |
| Roughness | 2.50 | 2.70 | 1.96 |
| Scattering | 81.60 | 70.11 | 79.80 |
| Opacity | 88.31 | 88.06 | 88.90 |
| Filler content | 30.1 | 30.8 | 30.3 |

The results show that at the same bulk the Composite sample had highest smoothness and opacity.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A gypsum-fibre composite product, comprising:
gypsum crystals on a surface of a fibre, wherein the gypsum crystals are obtained by contacting calcium sulphate hemihydrate and/or calcium sulphate anhydrite and an aqueous fibre suspension, and wherein the gypsum crystals have a size from 0.1 to 5.0 μm.

2. The gypsum-fibre composite product according to claim 1, wherein the calcium sulphate hemihydrate comprises α-calcium sulphate hemihydrate or β-calcium sulphate hemihydrate.

3. The gypsum-fibre composite product according to claim 1, wherein the fibre comprises a cellulosic fibre selected from the group consisting of kraft pulp fibre, mechanical pulp fibre, deinked pulp fibre and a synthetic fibre.

4. The gypsum-fibre composite product of claim 1, wherein gypsum crystals are at a weight ratio to the fibre on a dry basis of 95:5 to 50:50 by weight.

5. The gypsum-fibre composite product of claim 1, further comprising a natural or synthetic polymer binder and/or an optical brightener and/or a rheology modifier and/or a sizing agents.

6. A process for the preparation of a gypsum-fibre composite product comprising:
contacting calcium sulphate hemihydrate and/or calcium sulphate anhydrite and an aqueous fibre suspension and forming gypsum crystals on a surface of the fibre, wherein the gypsum crystals have a size from 0.1 to 5.0 μm.

7. The process according to claim 6, wherein the calcium sulphate hemihydrate comprises α-calcium sulphate hemihydrate or β-calcium sulphate hemihydrate.

8. The process according to claim 6, wherein the fibre comprises a cellulosic fibre selected from the group consisting of kraft pulp fibre, mechanical pulp fibre, deinked pulp fibre and a synthetic fibre.

9. The process of claim 6, wherein the weight ratio of gypsum crystals are at a weight ratio to the fibre on a dry basis of 95:5 to 50:50 by weight.

10. The process of claim 6, wherein the weight ratio of calcium sulphate hemihydrate and/or calcium anhydrite are at a weight ratio to water of 0.03 to 0.6:1 by weight.

11. The process of claim 6, wherein the dry fibre content is from 3 to 30% by weight of the gypsum-fibre composite product.

12. The process of claim 6, wherein the calcium sulphate hemihydrate and/or calcium anhydrite is from 5 to 57% by weight of the gypsum-fibre composite product.

13. The process of claim 6, further comprising drying and comminuting the obtained product to form a gypsum-fibre composite product in the form of particles.

14. The process of claim 6, wherein the crystallization is carried out in the absence of crystallization habit modifiers.

15. The process of claim 6, wherein the process is carried out in the presence of crystallization habit modifiers.

16. The process according to claim 15, wherein the crystallization habit modifier is added to water or the aqueous fibre suspension before contacting the calcium sulphate hemihydrate and/or calcium sulphate anhydrite.

17. The process of claim 15, wherein the crystallization habit modifier is a compound having one or several carboxylic or sulphonic acid groups, or a salt thereof.

18. The process according to claim 17, wherein the crystallization habit modifier is selected from the group consisting of ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), aminotriethoxy succinic acid, di- tetra- and hexa-sulfonic acids, alkylbenzenesulfonic acids and salts thereof.

19. The process of claim 15, wherein the crystallization habit modifier is used in an amount of 0.01 to 5.0%, based on the weight of the calcium sulphate hemihydrate and/or calcium sulphate anhydrite.

20. The process of claim 6, further comprising introducing a fixative during the contacting of the calcium sulphate hemihydrate and/or calcium sulphate anhydrite and the aqueous fibre suspension.

21. The process according to claim 20, wherein the fixative is selected from the group consisting of poly aluminum chloride, poly DADMAC, and anionic and cationic polyacrylates.

22. (canceled)

23. A paper product comprising the gypsum-fibre composite product of claim 1 as a filler pigment or coating pigment.

24. The paper product according to claim 23, wherein the amount of the gypsum-fibre composite product is from 10 to 60%, preferably from 20 to 50% by weight on dry basis.

25. The paper product of claim 23, comprising fine paper.
